(19) United States
(12) Patent Application Publication
(10) Pub. No.: US 2026/0167135 A1
(43) Pub. Date: Jun. 18, 2026

(54) METHOD TO IMPROVE RELIABILITY OF ECU USED IN POWERTRAIN APPLICATIONS

(71) Applicant: Cummins Inc., Columbus, IN (US)

(72) Inventor: Abhishek Khunte, Pune (IN)

(21) Appl. No.: 18/983,629

(22) Filed: Dec. 17, 2024

(51) Int. Cl. B60R 16/03; B60R 16/023

(52) U.S. Cl. CPC B60R 16/03; B60R 16/0231

(57) ABSTRACT

A power converter apparatus includes a parent circuit board comprising a first surface, a second surface, and a thermal conductor core disposed intermediate the first surface and the second surface. A first child circuit is board mounted on the parent circuit board. A first plurality of power switches is mounted on the first child circuit board. A second child circuit is board mounted on the parent circuit board. A second plurality of power switches are mounted on the second child circuit board. A first heat transfer circuit includes a first set of conductors thermally conductively coupling the first plurality of power switches with the thermal conductor core. A second heat transfer circuit includes a second set of conductors thermally conductively coupling the second plurality of power switches with the thermal conductor core.

### BACKGROUND

The present application relates to methods to improve reliability of electronic control units used in powertrain applications and related apparatuses, systems and techniques. A number of proposals have been made for addressing reliability of electronic control units used in powertrain applications. Existing approaches suffer from a number of disadvantages, drawbacks, problems, and shortcomings including those respecting complexity, cost, and reliability, among others. There remains a significant need for the unique apparatuses, processes, and systems disclosed herein.

### DISCLOSURE OF EXAMPLE EMBODIMENTS

For the purposes of clearly, concisely, and exactly describing example embodiments of the present disclosure, the manner, and process of making and using the same, and to enable the practice, making and use of the same, reference will now be made to certain example embodiments, including those illustrated in the figures, and specific language will be used to describe the same. It shall nevertheless be understood that no limitation of the scope of the invention is thereby created, and that the invention as set forth in the claims following this disclosure includes and protects such alterations, modifications, and further applications of the example embodiments as would occur to one skilled in the art with the benefit of the present disclosure.

### SUMMARY OF THE DISCLOSURE

Some embodiments include unique safety compliant catalyst heating aftertreatment apparatus. Some embodiments include unique safety compliant catalyst heating aftertreatment systems. Some embodiments include unique safety compliant catalyst heating aftertreatment processes. Further embodiments, forms, objects, features, advantages, aspects, and benefits shall become apparent from the following description and drawings.

### BRIEF DESCRIPTION OF THE DRAWINGS

FIG. 1 is a schematic diagram illustrating certain aspects of an example powertrain system.

FIG. 2 is a schematic diagram illustrating certain aspects of an example system including an electronic control unit.

FIGS. 3A and 3B are a schematic diagram illustrating certain aspects of example circuitry of an electronic control unit.

FIG. 4 is a flow diagram illustrating certain aspects of an example process.

FIG. 5 is a graph illustrating certain aspects of example controls.

### DETAILED DESCRIPTION OF EXAMPLE EMBODIMENTS

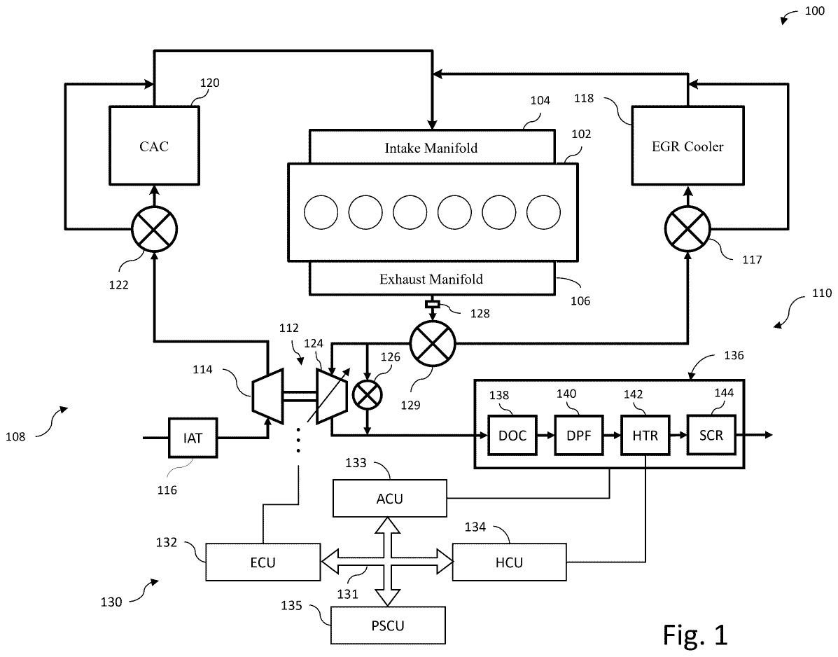

With reference to FIG. 1, there is illustrated an example powertrain system 100 (also referred to herein as system 100) including a prime mover in the form of an internal combustion engine (ICE) 102. System 100 may be provide in a number of forms including, for example, in the form of a vehicle or vehicle powertrain system (e.g., an on-highway vehicle or vehicle powertrain system or an off-highway vehicle or vehicle powertrain system), a work machine or work machine powertrain system, a genset or genset powertrain system, or a hydraulic fracturing rig or hydraulic fracturing rig powertrain system, to name several non-limiting examples. In shall be appreciated that system 100 may include a number of other components as will occur to one of skill in the art with the benefit and insight of the present disclosure. Furthermore, while engine 102 is provided as a prime mover of system 100 in the illustrated embodiment, other embodiments may comprise other types of prime movers, for example, battery electric drive systems, hybrid ICE-battery electric systems, a fuel cell electric drive system, or prime mover systems comprising combinations of the foregoing and/or other types of prime mover system as will occur to one of skill in the art with the benefit and insight of the present disclosure.

System 100 includes an intake system 108 and an exhaust system 110. The engine 102 is in fluid communication with the intake system 108 through which charge air enters an intake manifold 104 and is also in fluid communication with the exhaust system 110, through which exhaust gas resulting from combustion exits by way of an exhaust manifold 106. The engine 102 includes a number of cylinders (e.g., cylinders 1 through 6) forming combustion chambers in which a charge flow mixture of fuel and air is combusted. For example, the energy released by combustion powers the engine 102 via pistons in the cylinders connected to a crankshaft. Intake valves control the admission of charge air into the cylinders, and exhaust valves control the outflow of exhaust gas through exhaust manifold 106 and ultimately to the atmosphere. It shall be appreciated that the exhaust manifold 106 may be a single manifold or multiple exhaust manifolds.

The turbocharger 112 includes a compressor 114 configured to receive filtered intake air via an intake air throttle (IAT) 116 of the intake system 108 and operable to compress ambient air before the ambient air enters the intake manifold 104 of the engine 102 at increased pressure. The air from the compressor 114 is pumped through the intake system 108, to the intake manifold 104, and into the cylinders of the engine 102, typically producing torque on the crankshaft. IAT 116 is flow coupled with a charge air cooler (CAC) 120 which is operable to cool the charge flow provided to the intake manifold 104. The intake system 108 also includes a CAC bypass valve 122 which can be opened to route a portion or all of the charge flow to bypass the CAC 120. Adjusting the bypass position of the CAC bypass valve 122 increasingly raises the temperature of the gas returned to the intake manifold 104.

It is contemplated that in system 100, the turbocharger 112 may be a variable geometry turbocharger (VGT) or a fixed geometry turbocharger. A variable geometry turbine allows significant flexibility over the pressure ratio across the turbine. In diesel engines, for example, this flexibility can be used for improving low speed torque characteristics, reducing turbocharger lag and driving exhaust gas recirculation flow. In an example embodiment, the VGT 124 can be adjusted to increase engine load and thereby configured to increase exhaust gas temperature. System 100 also includes a turbine bypass valve 126 to bypass the turbocharger 112. Since cooler ambient air is introduced at the turbocharger 112, opening the turbine bypass valve 126 allows for the turbocharger 112 to be bypassed and maintain a higher intake air temperature at the intake manifold 104.

The exhaust system 110 includes an exhaust gas temperature sensor 128 to sense the temperature of the gas exiting the exhaust manifold 106. The exhaust system 110 includes an exhaust gas recirculation (EGR) valve 129 which recirculates a portion of exhaust gas from the exhaust manifold 106 back to the intake manifold 104. The exhaust system 110 includes an EGR cooler (EGR-C) 118 which cools the gas exiting the exhaust manifold 106 before the gas returns to the intake manifold 104. The exhaust system 110 may also include an EGR-C bypass valve 117 which can be opened to route a portion or all of the recirculated exhaust gas from the exhaust manifold 106 to bypass the EGR-C 118. By increasing the amount of gas that bypasses the EGR-C 118, the temperature of the gas returning to the intake manifold 104 is increased. It shall be appreciated that the intake system 108 and/or the exhaust system 110 may further include various components not shown, such as additional coolers, valves, bypasses, intake throttle valves, exhaust throttle valves, and/or compressor bypass valves, for example.

System 100 includes an exhaust aftertreatment (AT) system 136 which includes a diesel oxidation catalyst (DOC) 138, a diesel particulate filter (DPF) 140, aftertreatment (AT) heater 142, and a selective catalytic reduction (SCR) 144. In the example embodiment, the AT heater 142 is optionally included in the AT system 136 to increase the temperature of the exhaust gas provided to the SCR 144 within the AT system 136. It should be noted that AT heater 142 can include one or more electric heaters distributed at various locations at, on, within, or upstream of SCR 144 or other catalyst elements of AT system 136.

System 100 includes an electronic control system (ECS) 130. In the illustrated embodiment, ECS 130 includes a plurality of electronic control units (ECU) including an engine control module (ECM) 132, an aftertreatment control unit (ACU) 133, a heater control unit (HCU) 134, and power system control unit (PSCU) 135 which are operatively communicatively coupled with one another via one or more datalinks 131 which may comprise one or more controller area networks (CAN) and/or other types of datalinks. System 100 may include a number of other control units and controller as will occur to one of skill in the art with the benefit and insight of the present disclosure.

ECM 132 is operatively communicatively coupled with and configured and operable to control operation of and/or receive inputs from actuators, controllers, devices, sensors, and/or other components of system 100 including, for example, a number of the aforementioned features of system 100.

HCU 134 is operatively coupled with and configured and operable to control operation of and/or receive inputs from AT heater 142. It shall be appreciated that various communications hardware and protocols may be utilized to implement, such as one or more controller area networks (CAN) or other communications components.

PSCU 135 operatively communicatively coupled with and configured and operable to control operation of and/or receive inputs from an electrical power system of system 100 such as, for example, a motor generator system, a battery system, or other types of electrical power systems.

ECM 132, ACU 133, HCU 134, PSCU 135, and other components of ECS 130 may include one or more programmable controllers of a solid-state, integrated circuit type, and one or more non-transitory memory media configured to store instructions executable by the one or more microcontrollers. For purposes of the present application the term controller shall be understood to also encompass microcontrollers, microprocessors, application specific integrated circuits (ASIC), other types of integrated circuit processors and combinations thereof.

ECM 132, ACU 133, HCU 134, PSCU 135, and other components of ECS 130 may be implemented in any of a number of ways that combine or distribute the control function across one or more control units in various manners. The ECS 130 may execute operating logic that defines various control, management, and/or regulation functions. This operating logic may be in the form of dedicated hardware, such as a hardwired state machine, analog calculating machine, programming instructions, and/or a different form as would occur to those skilled in the art. The ECS 130 may be provided as a single component or a collection of operatively coupled components; and may be comprised of digital circuitry, analog circuitry, or a hybrid combination of both of these types. When of a multi-component form, the ECS 130 may have one or more components remotely located relative to the others in a distributed arrangement. The ECS 130 can include multiple processing units arranged to operate independently, in a pipeline processing arrangement, in a parallel processing arrangement, or the like. It shall be further appreciated that the ECS 130 and/or any of its constituent components may include one or more signal conditioners, modulators, demodulators, Arithmetic Logic Units (ALUs), Central Processing Units (CPUs), limiters, oscillators, control clocks, amplifiers, signal conditioners, filters, format converters, communication ports, clamps, delay devices, memory devices, Analog to Digital (A/D) converters, Digital to Analog (D/A) converters, and/or different circuitry or components as would occur to those skilled in the art to perform the desired communications.

ECM 132, ACU 133, HCU 134, PSCU 135, and other components of ECS 130 may include one or more non-transitory memory devices configured to store instructions in memory which are readable and executable by a controller to control operation of engine 102 as described herein. Certain control operations described herein include operations to determine one or more parameters. ECM 132, ACU 133, HCU 134, PSCU 135, and other components of ECS 130 may be configured to determine and may perform acts of determining in a number of manners, for example, by calculating or computing a value, obtaining a value from a lookup table or using a lookup operation, receiving values from a datalink or network communication, receiving an electronic signal (e.g., a voltage, frequency, current, or pulse-width modulation (PWM) signal) indicative of the value, receiving a parameter indicative of the value, reading the value from a memory location on a computer-readable medium, receiving the value as a run-time parameter, and/or by receiving a value by which the interpreted parameter can be calculated, and/or by referencing a default value that is interpreted to be the parameter value.

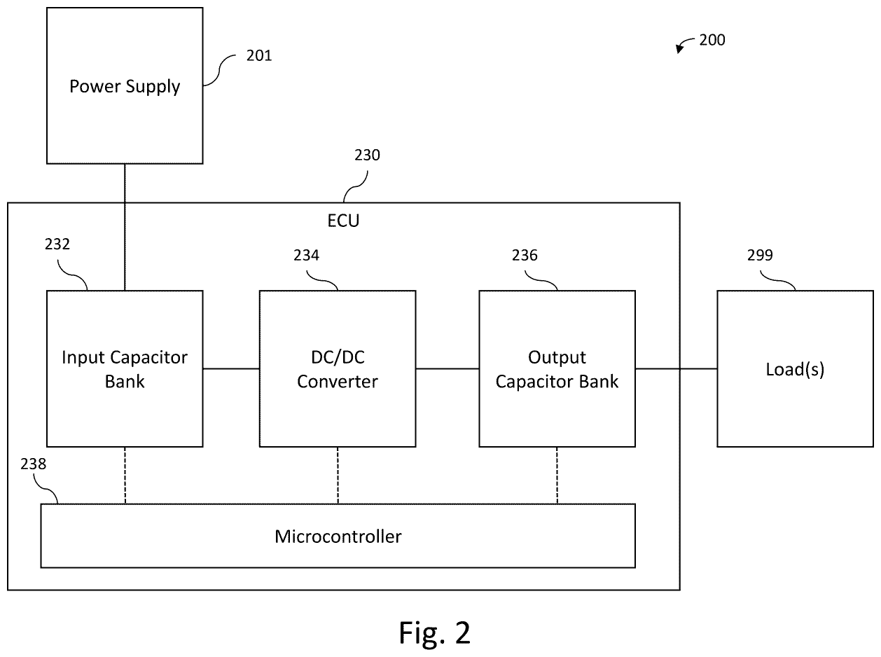

With reference to FIG. 2, there are illustrated certain aspects of an example system 200 including an electronic control unit (ECU) 230 operatively coupled with a power supply 201 and one or more electrical loads 299. ECU 230 may be configured and provided as an electronic control unit of ECS 130 or another electronic control system, or another component or portion of ECS 130 or another electronic control system. Power supply 201 may be configured and provided in a number of forms and may comprise one or more of a battery, battery system, supercapacitor(s), and/or other energy storage system components as will occur to one of skill in the art with the benefit and insight of the present disclosure. Electrical loads 299 may be configured and provided in a number of forms and may comprise loads of various impedances including, for example, capacitive loads, inductive loads, and hybrid or mixed loads of various forms as will occur to one of skill in the art with the benefit and insight of the present disclosure.

ECU 230 comprises an input capacitor bank 232 which is operatively coupled with power supply 201. Input capacitor bank 232 is operatively coupled with a first side of DC/DC converter 234. Output side of DC/DC converter 234 is operatively coupled with output capacitor bank 236. Microcontroller 238 is operatively coupled with and configured to control input capacitor bank 232, DC/DC converter 234, and output capacitor bank 236 as further described herein. In some embodiments, only one of input capacitor bank 232 and output capacitor bank 236 may be present in ECU 230 with the other thereof being omitted.

DC/DC converter 234 may be configured and provided in a number of forms including buck converter or step-down converter forms, boost converter or step-up converter forms, buck-boost converter, interleaved or multiphase buck converter and boost converter forms, other forms as will occur to one of skill in the art with the benefit and insight of the present disclosure. DC/DC converter 234 is bay be configured and provided as a unidirectional DC/DC converter or a bidirectional DC/DC converter.

It shall be appreciated that switched capacitor banks, such as input capacitor bank 232 and output capacitor bank 236, may be controlled to selectably increase the capacitance provided by the capacitor bank by effectively adding capacitors thereto. Such operation may be utilized in a number of operating scenarios. For example, in some such scenarios, sudden inrush current can be controlled by periodically closing switches provided between auxiliary capacitors and the other capacitors of the capacitor bank to provide an increased capacitance capable of handling greater inrush current and avoiding over-current damage to devices coupled therewith.

Input capacitor bank 232 may be provided in a number of forms comprising a first set of capacitors which are unselectably coupled with a power bus and a second set of capacitors which are selectably coupleable and decoupleable from the power bus by operation of a switch in response to control signals from microcontroller 238. Output capacitor bank 236 may be provided in a number of forms comprising a first set of capacitors which are unselectably coupled with a power bus and a second set of capacitors which are selectably coupleable and decoupleable from the power bus by operation of a switch in response to control signals from microcontroller 238.

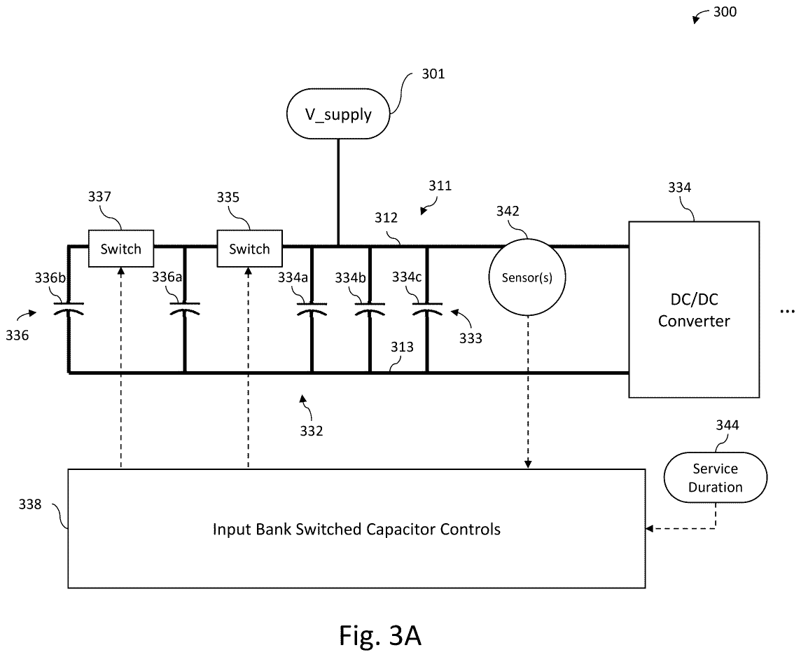

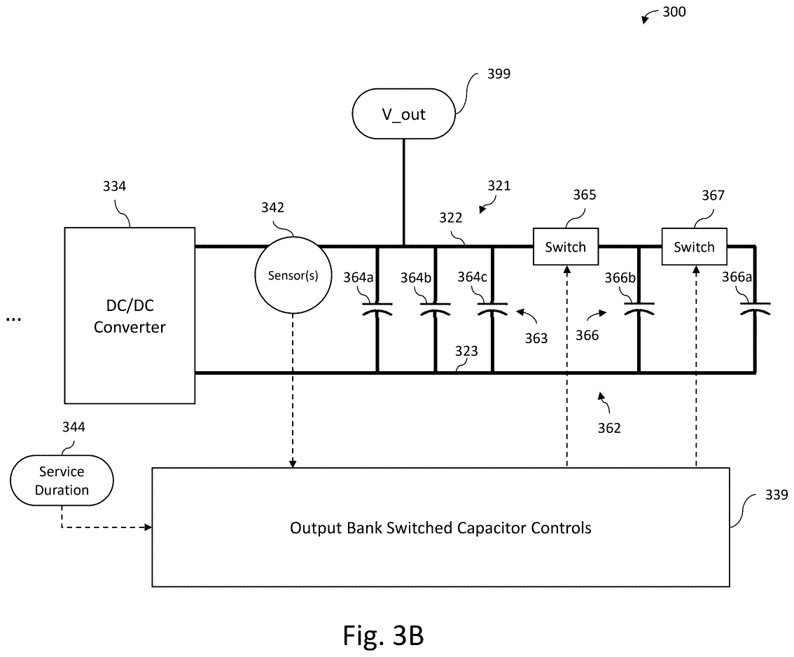

FIGS. 3A and 3B are a schematic diagram illustrating certain aspects of example circuitry 300 of an electronic control unit. Circuitry 300 may be implemented and provided in ECU 230, another electronic control unit of ECS 130, or another electronic control unit of another electronic control system in accordance with the present disclosure. Circuitry 300 includes DC/DC converter 334 which may be configured and provided in a number of forms including, for example, the forms illustrated and described in connection with DC/DC converter 234.

As illustrated in FIG. 3A, an inputs side of DC/DC converter 334 is operatively coupled with DC power bus 311 including positive rail 312 and negative rail 313. A power supply voltage 301 is present at positive rail 312 to receive power from one or more power supplies.

An input capacitor bank 332 is operatively coupled with DC power bus 311 and includes a set of dedicated capacitors 333 which are unselectably coupled with DC power bus 311. In the illustrated example, set of dedicated capacitors 333 comprises capacitors 334a, 334b, 334c which are arranged in a parallel relationship. In other embodiments, set of dedicated capacitors 333 may include a greater or lesser number of capacitors and may comprise capacitors coupled in series between positive rail 312 and negative rail 313 or parallel subsets of capacitors coupled in series between positive rail 312 and negative rail 313.

Input capacitor bank 332 includes a set of auxiliary capacitors 336 which are selectably coupleable and decoupleable from DC power bus 311. In the illustrated example, set of auxiliary capacitors 336 comprises capacitors 336a, 336b which are arranged in a parallel relationship. In other embodiments, set of auxiliary capacitors 336 may include a greater or lesser number of capacitors and may comprise capacitors coupled in series between positive rail 312 and negative rail 313 or parallel subsets of capacitors coupled in series between positive rail 312 and negative rail 313.

Switch 335 is controllable to selectably coupled and decouple capacitors 336a, 336b from DC power bus 311 and the set of dedicated capacitors 333. Switch 337 is controllable to selectably coupled and decouple capacitor 336b from DC power bus 311, the set of dedicated capacitors 333, and capacitor 336a.

Input bank switched capacitor controls 338 may be implemented in connection with one or more integrated circuit-based controllers such microcontroller 238 or another integrated circuit-based controller which may be referred to generally herein simply as a controller. Input bank switched capacitor controls 338 are configured to receive input 344 indicative of a service duration associated with circuitry 300 and/or component(s) thereof, for example, a service on time or a net service age associated with circuitry 300, an electronic control unit in which circuitry 300 is implemented, a system in which such electronic control unit is implemented, or other inputs indicative of a service duration associated with circuitry 300 and/or component(s) thereof, it being appreciated that the foregoing and other service duration parameters comprise may be referred to herein as service duration of an electronic control unit. Such input indicative of a service duration may be provided by or in connection with a timer or counter configured to increment during service or operation of circuitry 300 and/or component(s) thereof, and/or during service or operation of an electronic control unit or system associated therewith.

Input bank switched capacitor controls 338 are configured to receive inputs from one or more sensors 342. The one or more sensors 342 may comprise one or more voltage sensors configured to provide one or more inputs indicative of a voltage of DC power bus 311. The one or more sensors 342 may comprise one or more temperature sensors configured to configured to provide one or more inputs indicative of a temperature the set of dedicated capacitors 333 and/or other components of circuitry 300. The one or more sensors 342 may comprise one or more current sensors configured to provide one or more inputs indicative of current of DC power bus 311 or DC/DC converter 334. The one or more sensors 342 may comprise other sensors as will occur to one of skill in the art with the benefit and insight of the present disclosure.

Input bank switched capacitor controls 338 are configured to output control signals in response to received inputs to control operation of switch 335 and switch 337 in accordance with the controls and processes of the present disclosure. Such controls and processes may comprise logic configured to selectably coupled or decoupled one or both of capacitors 336a, 336b from DC power bus 311 and the other components coupled therewith in in response to conditions of circuitry 300 such as service duration, temperature, and ripple current associated with circuitry 300.

As illustrated in FIG. 3B, an inputs side of DC/DC converter 334 is operatively coupled with DC power bus 321 including positive rail 322 and negative rail 323. An output voltage 399 is output by positive rail 322 to drive one or more loads coupled therewith.

An output capacitor bank 362 is operatively coupled with DC power bus 321 and includes a set of dedicated capacitors 363 which are unselectably coupled with DC power bus 321. In the illustrated example, set of dedicated capacitors 363 comprises capacitors 364a, 364b, 364c which are arranged in a parallel relationship. In other embodiments, set of dedicated capacitors 363 may include a greater or lesser number of capacitors and may comprise capacitors coupled in series between positive rail 322 and negative rail 323 or parallel subsets of capacitors coupled in series between positive rail 322 and negative rail 323.

Output capacitor bank 362 includes a set of auxiliary capacitors 366 which are selectably coupleable and decoupleable from DC power bus 321. In the illustrated example, set of auxiliary capacitors 366 comprises capacitors 366a, 366b which are arranged in a parallel relationship. In other embodiments, set of auxiliary capacitors 366 may include a greater or lesser number of capacitors and may comprise capacitors coupled in series between positive rail 322 and negative rail 323 or parallel subsets of capacitors coupled in series between positive rail 322 and negative rail 323.

Switch 365 is controllable to selectably coupled and decouple capacitors 366a, 366b from DC power bus 321 and the set of dedicated capacitors 363. Switch 367 is controllable to selectably coupled and decouple capacitor 366b from DC power bus 321, the set of dedicated capacitors 363, and capacitor 366a.

Input bank switched capacitor controls 339 may be implemented in connection with one or more integrated circuit-based controllers such microcontroller 238 or another integrated circuit-based controller. Input bank switched capacitor controls 339 are configured to receive input 344.

Input bank switched capacitor controls 339 are configured to receive inputs from one or more sensors 342. The one or more sensors 342 may comprise one or more voltage sensors configured to provide one or more inputs indicative of a voltage of DC power bus 321. The one or more sensors 342 may comprise one or more temperature sensors configured to configured to provide one or more inputs indicative of a temperature the set of dedicated capacitors 363 and/or other components of circuitry 300. The one or more sensors 342 may comprise one or more current sensors configured to provide one or more inputs indicative of current of DC power bus 321 or DC/DC converter 364. The one or more sensors 342 may comprise other sensors as will occur to one of skill in the art with the benefit and insight of the present disclosure.

Input bank switched capacitor controls 339 are configured to output control signals in response to received inputs to control operation of switch 365 and switch 367 in accordance with the controls and processes of the present disclosure. Such controls and processes may comprise logic configured to selectably coupled or decoupled one or both of capacitors 366a, 366b from DC power bus 321 and the other components coupled therewith in in response to conditions of circuitry.

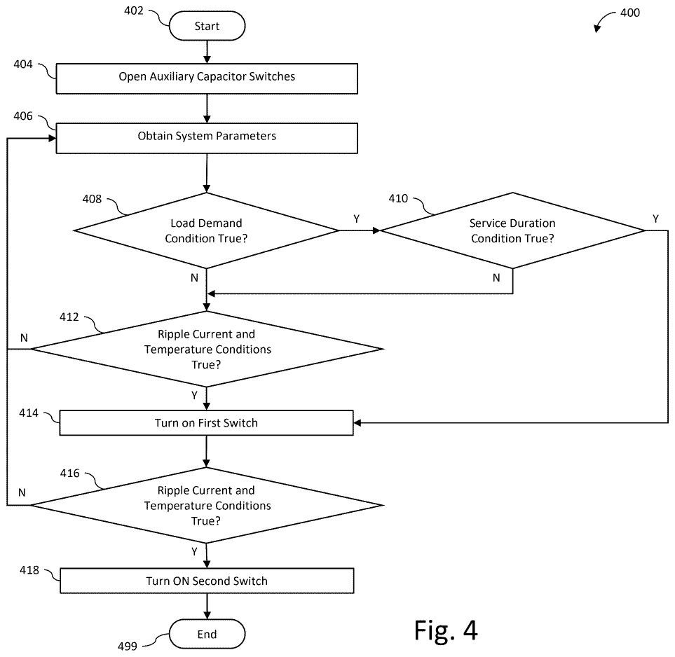

FIG. 4 is a flow diagram illustrating certain aspects of an example process 400 which may be implemented in and executed by one or more control components such as input bank switched capacitor controls 338, output bank switched capacitor controls 339, or other controls according to the present disclosure.

At start state 402, process 400 is initiated and proceeds to operation 404 which opens one or more switches effective to isolate or decouple one or more auxiliary capacitors from a DC power bus, for example, in the context of circuitry 300, by opening one or both of switch 335 and switch 337 to decoupled or isolate one or both of capacitors 336a, 336b from DC power bus 311, or by opening one or both of switch 365 and switch 367 to decoupled or isolate one or both of capacitors 366a, 366b from DC power bus 321.

From operation 404, process 400 proceeds to operation 406 which obtains one or more operating parameters associated with a system associated with process 400. The operating parameters obtained at operation 404 may comprise a voltage of a DC power bus or DC/DC converter coupled therewith. The operating parameters obtained at operation 404 may comprise one or more parameters indicative of a service duration of associated circuitry or component(s) thereof, an associated electronic control unit or component(s) thereof, and/or an associated system or the component(s) thereof. The operating parameters obtained at operation 404 may comprise a temperature parameter indicative of a temperature of one or more capacitors and/or other components of circuitry associated with process 400. The operating parameters obtained at operation 404 may comprise a load demand of the DC power bus or DC/DC converter coupled therewith, for example, a measured or estimated load demand such as a measured or estimated DC/DC converter output, or a commanded load demand or load supply parameter such as a commanded DC/DC converter output.

The operating parameters obtained at operation 404 may comprise a parameter indicative of a ripple voltage of the DC power bus or DC/DC converter coupled therewith. The parameter indicative of a ripple voltage may be determined or estimated in response to other parameters, for example, an ripple voltage of the DC power bus or DC/DC converter coupled therewith (for example, an input ripple voltage associated with the DC/DC converter), an input bus voltage, a load demand of the DC power bus or DC/DC converter coupled therewith (for example, a measured or estimated load demand, or a commanded load demand parameter), a frequency of the DC power bus or DC/DC converter coupled therewith, and/or other parameters from which a ripple current may be determined or estimated as will occur to one of skill in the art with the benefit and insight of the present disclosure.

From operation 406, process 400 proceeds to conditional 408 which evaluates whether a load demand condition is true. The load demand condition may comprise an DC/DC converter output power exceeding an output power threshold or limit. The DC/DC converter output may be a measured or estimated DC/DC converter output or a commanded DC/DC converter output. If conditional 408 evaluates affirmative, process 400 proceeds to conditional 410. If conditional 408 evaluates negative, process 400 proceeds to conditional 412.

Conditional 410 evaluates whether a service duration condition is true. The service duration condition may comprise a service duration parameter exceeding a service duration threshold or limit. The service duration parameter may comprise a service on time or a net service age associated with component(s), circuitry, an electronic control unit, and/or a system associated with process 400 and may be provided by or in connection with a timer or counter configured to increment during service or operation of such component(s), circuitry, electronic control unit, and/or system. It shall be appreciated that a service duration is one example of a degradation condition according to the present disclosure. If conditional 410 evaluates affirmative, process 400 proceeds to operation 414. If conditional 410 evaluates negative, process 400 proceeds to conditional 412.

Conditional 412 evaluates whether ripple current and temperature conditions are true. The ripple current condition may comprise a ripple current associated with a DC/DC converter and/or a DC power bus operatively coupled therewith. The temperature condition may comprise a temperature parameter indicative of a temperature of one or more capacitors and/or other components of circuitry associated with process 400. It shall be appreciated that ripple current and temperature conditions are an example of a degradation condition according to the present disclosure.

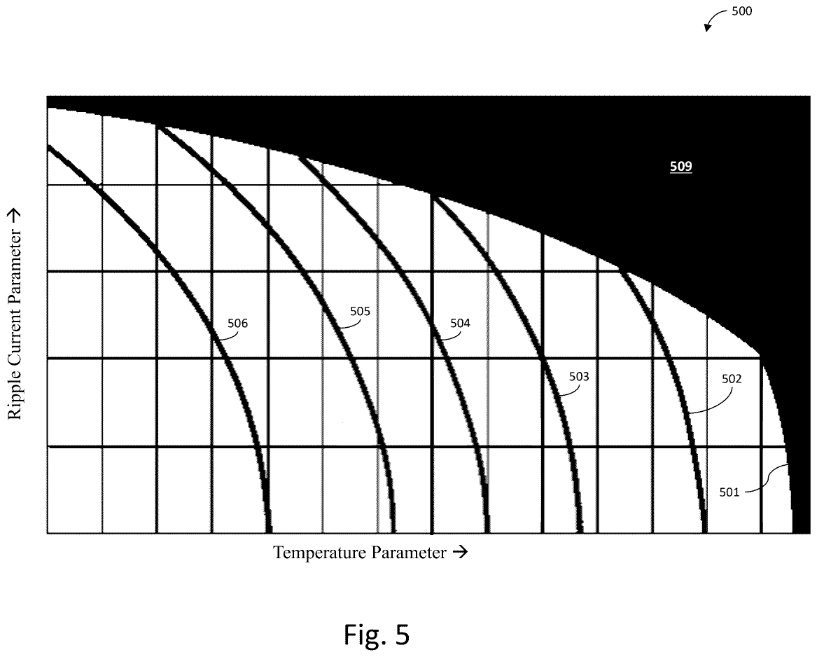

Conditional 412 may evaluate a ripple current condition and a temperature condition separately, for example, by evaluating whether a ripple current condition exceeds a ripple current threshold and by evaluating whether a temperature condition exceeds a temperature threshold. Conditional 412 may evaluate a ripple current condition and a temperature condition in combination, for example, by evaluating whether a parameter responsive to both a ripple current condition and a temperature condition exceeds a parameter threshold, such as described in connection with FIG. 5. If conditional 412 evaluates affirmative, process 400 proceeds to operation 414. If conditional 412 evaluates negative, process 400 proceeds to operation 406.

Operation 414 turns on a first switch associated with a set of auxiliary capacitors operatively coupled with a DC power bus and a DC/DC converter. The set of auxiliary capacitors may be coupled with an input side of the DC/DC converter. The set of auxiliary capacitors may be coupled with an output side of the DC/DC converter. One subset of the set of auxiliary capacitors may be coupled with an input side of the DC/DC converter and another subset of the set of auxiliary capacitors may be coupled with an output side of the DC/DC converter. In the context of circuitry 300, operation 414 may turn on switch 335, switch 365, or both switch 335 and switch 365.

From operation 414, process 400 proceeds to conditional 416 which evaluates whether ripple current and temperature conditions are true. Such evaluation may be the same as or substantially similar to the evaluation performed by conditional 412. If conditional 416 evaluates affirmative, process 400 proceeds to operation 418. If conditional 416 evaluates negative, process 400 proceeds to operation 418.

Operation 418 turns on a second switch associated with a set of auxiliary capacitors operatively coupled with a DC power bus and a DC/DC converter. The set of auxiliary capacitors may be coupled with an input side of the DC/DC converter. The set of auxiliary capacitors may be coupled with an output side of the DC/DC converter. One subset of the set of auxiliary capacitors may be coupled with an input side of the DC/DC converter and another subset of the set of auxiliary capacitors may be coupled with an output side of the DC/DC converter. In the context of circuitry 300, operation 414 may turn on switch 337, switch 367, or both switch 337 and switch 367. From operation 418, process 400 proceeds to end state 499 and may thereafter be recalled or repeated.

It shall be appreciated that execution of process 400 may be effective to operate a switch to couple to a set of auxiliary capacitors with a power bus in response a load demand on a DC/DD power converter exceeding a load demand threshold and either one or both of a service age of the set of auxiliary capacitors exceeding a service age threshold a one or more thresholds associate with a ripple current and a temperature of the set of auxiliary capacitors being exceed.

FIG. 5 is a graph illustrating certain aspects of example controls which may be provided and executed by and in connection with process 400 or other processes, input bank switched capacitor controls 338, output bank switched capacitor controls 339 and/or other control components of circuitry 300 or other circuitry, and/or control components of ECU 230 or other electronic control units.

Graph 500 depicts a ripple current parameter on its vertical axis. The ripple current parameter may comprise, for example a ratio of a frequency specific ripple current (I_AC) to a rated ripple factor (I_ACR), that is I_AC/I+ACF. The frequency specific ripple current (I_AC) may comprise an actual or estimated ripple current divided by a frequency factor of permissible ripple current associated with a given capacitor and corresponding to a frequency associated with the capacitor.

Graph 500 depicts a temperature parameter on its horizontal axis. The temperature parameter may comprise a temperature indicative of a temperature of a capacitor and/or other component(s) of circuitry such as circuitry 300. Graph 500 further depicts a plurality of curves 501, 502, 503, 504, 505, 506 and a null region 509. Null region 509 is bounded by curve 501 and indicates a region with temperature and ripple current conditions under which an expected or predicted service life of a capacitor is null or below a minimum permissible level. Curve 501 indicates combinations of temperature and ripple current conditions under which an expected or predicted service life of a capacitor has a first magnitude (e.g., 1000 hours). Curve 502 indicates combinations of temperature and ripple current conditions under which an expected or predicted service life of a capacitor has a second magnitude (e.g., 2000 hours). Curve 503 indicates combinations of temperature and ripple current conditions under which an expected or predicted service life of a capacitor has a third magnitude (e.g., 5000 hours). Curve 504 indicates combinations of temperature and ripple current conditions under which an expected or predicted service life of a capacitor has a fourth magnitude (e.g., 10000 hours). Curve 505 indicates combinations of temperature and ripple current conditions under which an expected or predicted service life of a capacitor has a fifth magnitude (e.g., 20000 hours). Curve 506 indicates combinations of temperature and ripple current conditions under which an expected or predicted service life of a capacitor has a sixth magnitude (e.g., 50000 hours). Expected service life magnitudes for states intermediate two of curves 501, 502, 503, 504, 505, 506 may be determined by interpolating therebetween.

The relationships illustrated in graph 500 may be implemented in and/or used to configure controls of an electronic control system component such as a microcontroller or other integrated circuit-based controller of an electronic control unit. Such implementation may comprise providing one or more three-dimensional lookup tables wherein a temperature parameter is input to the X-axis of the table, a ripple current parameter is input to the Y-axis of the table, and an estimated or predicted useful life parameter is output from the Z-axis of the table. It shall be appreciated that the values of such lookup tables may be determined and programmed based on empirical data, physical relationships, or combinations thereof. It shall also be appreciated that interpolation such as described in connection with graph 500 may be utilized. It shall be further appreciated that other techniques such as run-time calculations, formula solvers, or other logical operations may be utilized in place of or in addition to one or more lookup tables. Example controls utilizing the relationships illustrated in graph 500 may compare an estimated or predicted useful life parameter output or otherwise determined by the controls to a predetermined threshold. It shall be appreciated that and estimated or predicted useful life parameter one example of a degradation condition according to the present disclosure.

As shown by this detailed description, the present disclosure contemplates multiple and various embodiments, including, without limitation, the following example embodiments.

A first example embodiment is a system comprising: a powertrain system including a prime mover; a power supply; and an electronic control unit (ECU) operatively coupled with and configured to output electrical power to one or more components of the powertrain system, the electronic control unit comprising a power converter operatively coupled with the power supply, a capacitor bank operatively coupled with one of an input of the power converter and an output of the power converter, the capacitor bank comprising a first set of capacitors unselectably coupled with a power bus and a second set of capacitors selectably coupleable and decoupleable from the power bus by operation of a switch, and a controller configured to operate the switch to couple the second set of capacitors with the power bus in response to a combination of system conditions including a load demand condition of the power converter and one or more degradation conditions of the first set of capacitors.

A second example embodiment includes the features of the first example embodiment, wherein the load demand condition comprises a converter output power being greater than an output power threshold.

A third example embodiment includes the features of the first example embodiment, wherein the one or more degradation conditions comprises a service duration of the ECU being greater than a service duration threshold.

A fourth example embodiment includes the features of the first example embodiment, wherein the one or more degradation conditions comprises a ripple current of the capacitor bank and a temperature of the first set of capacitors satisfying a ripple current and temperature criterion.

A fifth example embodiment includes the features of the first example embodiment, wherein the controller is configured operate the switch to couple the second set of capacitors with the power bus in response to either of: (a) the load demand on the power converter exceeding a load demand threshold and a service age of the first set of capacitors exceeding a service age threshold, and (b) the load demand on the power converter exceeding a load demand threshold and a one or more thresholds for a ripple current and a temperature of the first set of capacitors being exceed.

A sixth example embodiment includes the features of the first example embodiment, wherein: the capacitor bank comprises a third set of capacitors selectably coupleable and decoupleable from the power bus by operation of a second switch, and the controller is configured to operate the second switch to couple the third set of capacitors with the power bus in response to the combination of system conditions.

A seventh example embodiment includes the features of the sixth example embodiment, wherein the microcontroller is configured to first evaluate the combination of system conditions to control the first switch and thereafter second evaluate the combination of system conditions to control the second switch.

An eighth example embodiment is a process of operating a powertrain system including a prime mover, the process comprising: operating an electronic control unit of the powertrain system to output electrical power to one or more components of the powertrain system, the electronic control unit including a DC/DC power converter operatively coupled with a power supply and a capacitor bank operatively coupled with one of an input of the DC/DC power converter and an output of the power converter and including a set of dedicated capacitors coupled with a DC power bus and one or more auxiliary capacitors selectably coupled with the a DC power bus; and closing at least a first one of one or more switches to couple the one or more auxiliary capacitors with the DC power bus in response to a plurality of conditions including a load demand condition of the DC/DC power converter and one or more degradation conditions of the set of dedicated capacitors.

A ninth example embodiment includes the features of the eighth example embodiment, wherein the load demand condition comprises a converter output power being greater than an output power threshold.

A tenth example embodiment includes the features of the eighth example embodiment, wherein the one or more degradation conditions comprises a service duration of associated with the electronic control unit being greater than a service duration threshold.

An eleventh example embodiment includes the features of the eighth example embodiment, wherein the one or more degradation conditions comprises a ripple current of the capacitor bank and a temperature of the first set of capacitors satisfying a ripple current and temperature criterion.

A twelfth example embodiment includes the features of the eighth example embodiment, wherein the closing one or more switches occurs in response to either of: (a) the load demand on the power converter exceeding a load demand threshold and a service age of the first set of capacitors exceeding a service age threshold, and (b) the load demand on the power converter exceeding a load demand threshold and a one or more thresholds for a ripple current and a temperature of the first set of capacitors being exceed.

A thirteenth example embodiment includes the features of the eighth example embodiment, wherein: the capacitor bank comprises a third set of capacitors selectably coupleable and decoupleable from the power bus by operation of a second switch, and closing a second one of the one or more switches occurs in response to the plurality of conditions.

A fourteenth example embodiment includes the features of the eighth example embodiment, wherein a the closing the second one of the one or more switches occurs after the closing at least one of the one of the one or more switches.

A fifteenth example embodiment, is an electronic control unit configured to control one or aspects of a powertrain system including a prime mover, the electronic control unit comprising: one or more non-transitory controller readable media configured with instruction executable by a controller to: operate the electronic control to output electrical power to one or more components of the powertrain system using a DC/DC power converter operatively coupled with a power supply and a capacitor bank operatively coupled with one of an input of the DC/DC power converter and an output of the power converter and including a set of dedicated capacitors coupled with a DC power bus and one or more auxiliary capacitors selectably coupled with the a DC power bus; and close at least a first one of one or more switches to couple the one or more auxiliary capacitors with the DC power bus in response to a plurality of conditions including a load demand condition of the DC/DC power converter and one or more degradation conditions of the set of dedicated capacitors.

A sixteenth example embodiment includes the features of the fifteenth example embodiment, wherein the load demand condition comprises a converter output power being greater than an output power threshold.

A seventeenth example embodiment includes the features of the fifteenth example embodiment, wherein the one or more degradation conditions comprises a service duration of the electronic control unit being greater than a service duration threshold.

An eighteenth example embodiment includes the features of the fifteenth example embodiment, wherein the one or more degradation conditions comprises a ripple current of the capacitor bank and a temperature of the first set of capacitors satisfying a ripple current and temperature criterion.

A nineteenth example embodiment includes the features of the fifteenth example embodiment, wherein the instructions to close one or more switches are configured to occur in response to at least one of: (a) the load demand on the power converter exceeding a load demand threshold and a service age of the first set of capacitors exceeding a service age threshold, and (b) the load demand on the power converter exceeding a load demand threshold and a one or more thresholds for a ripple current and a temperature of the first set of capacitors being exceed.

A twentieth example embodiment includes the features of the fifteenth example embodiment, wherein the instructions to close one or more switches are configured to occur in response to both of: (a) the load demand on the power converter exceeding a load demand threshold and a service age of the first set of capacitors exceeding a service age threshold, and (b) the load demand on the power converter exceeding a load demand threshold and a one or more thresholds for a ripple current and a temperature of the first set of capacitors being exceed.

It shall be appreciated that terms such as “a non-transitory memory,” “a non-transitory memory medium,” and “a non-transitory memory device” refer to a number of types of devices and storage mediums which may be configured to store information, such as data or instructions, readable or executable by a processor or other components of a computer system and that such terms include and encompass a single or unitary device or medium storing such information, multiple devices or media across or among which respective portions of such information are stored, and multiple devices or media across or among which multiple copies of such information are stored.

It shall be appreciated that terms such as “determine,” “determined,” “determining” and the like when utilized in connection with a control method or process, an electronic control system or controller, electronic controls, or components or operations of the foregoing refer inclusively to a number of acts, configurations, devices, operations, and techniques including, without limitation, calculation or computation of a parameter or value, obtaining a parameter or value from a lookup table or using a lookup operation, receiving parameters or values from a datalink or network communication, receiving an electronic signal (e.g., a voltage, frequency, current, or pulse-width modulation (PWM) signal) indicative of the parameter or value, receiving output of a sensor indicative of the parameter or value, receiving other outputs or inputs indicative of the parameter or value, reading the parameter or value from a memory location on a computer-readable medium, receiving the parameter or value as a run-time parameter, and/or by receiving a parameter or value by which the interpreted parameter can be calculated, and/or by referencing a default value that is interpreted to be the parameter value.

While example embodiments of the disclosure have been illustrated and described in detail in the drawings and foregoing description, the same is to be considered as illustrative and not restrictive in character, it being understood that only certain example embodiments have been shown and described and that all changes and modifications that come within the spirit of the claimed inventions are desired to be protected. It should be understood that while the use of words such as preferable, preferably, preferred or more preferred utilized in the description above indicates that the feature so described may be more desirable, it nonetheless may not be necessary and embodiments lacking the same may be contemplated as within the scope of the invention, the scope being defined by the claims that follow. In reading the claims, it is intended that when words such as “a,” “an,” “at least one,” or “at least one portion” are used there is no intention to limit the claim to only one item unless specifically stated to the contrary in the claim. When the language “at least a portion” and/or “a portion” is used the item can include a portion and/or the entire item unless specifically stated to the contrary.

What is claimed is:

1. A system comprising:
a powertrain system including a prime mover;
a power supply; and
an electronic control unit (ECU) operatively coupled with and configured to output electrical power to one or more components of the powertrain system, the electronic control unit comprising
a power converter operatively coupled with the power supply,
a capacitor bank operatively coupled with one of an input of the power converter and an output of the power converter, the capacitor bank comprising a first set of capacitors unselectably coupled with a power bus and a second set of capacitors selectably coupleable and decoupleable from the power bus by operation of a switch, and
a controller configured to operate the switch to couple the second set of capacitors with the power bus in response to a combination of system conditions including a load demand condition of the power converter and one or more degradation conditions of the first set of capacitors.

2. The system of claim 1, wherein the load demand condition comprises a converter output power being greater than an output power threshold.

3. The system of claim 1, wherein the one or more degradation conditions comprises a service duration of the ECU being greater than a service duration threshold.

4. The system of claim 1, wherein the one or more degradation conditions comprises a ripple current of the capacitor bank and a temperature of the first set of capacitors satisfying a ripple current and temperature criterion.

5. The system of claim 1, wherein the controller is configured operate the switch to couple the second set of capacitors with the power bus in response to either of:
(a) the load demand on the power converter exceeding a load demand threshold and a service age of the first set of capacitors exceeding a service age threshold, and
(b) the load demand on the power converter exceeding a load demand threshold and a one or more thresholds for a ripple current and a temperature of the first set of capacitors being exceed.

6. The system of claim 1, wherein:
the capacitor bank comprises a third set of capacitors selectably coupleable and decoupleable from the power bus by operation of a second switch, and
the controller is configured to operate the second switch to couple the third set of capacitors with the power bus in response to the combination of system conditions.

7. The system of claim 6, wherein the microcontroller is configured to first evaluate the combination of system conditions to control the first switch and thereafter second evaluate the combination of system conditions to control the second switch.

8. A process of operating a powertrain system including a prime mover, the process comprising:
operating an electronic control unit of the powertrain system to output electrical power to one or more components of the powertrain system, the electronic control unit including a DC/DC power converter operatively coupled with a power supply and a capacitor bank operatively coupled with one of an input of the DC/DC power converter and an output of the power converter and including a set of dedicated capacitors coupled with a DC power bus and one or more auxiliary capacitors selectably coupled with the a DC power bus; and
closing at least a first one of one or more switches to couple the one or more auxiliary capacitors with the DC power bus in response to a plurality of conditions including a load demand condition of the DC/DC power converter and one or more degradation conditions of the set of dedicated capacitors.

9. The process of claim 8, wherein the load demand condition comprises a converter output power being greater than an output power threshold.

10. The process of claim 8, wherein the one or more degradation conditions comprises a service duration of associated with the electronic control unit being greater than a service duration threshold.

11. The process of claim 8, wherein the one or more degradation conditions comprises a ripple current of the capacitor bank and a temperature of the first set of capacitors satisfying a ripple current and temperature criterion.

12. The process of claim 8, wherein the closing one or more switches occurs in response to either of:
(a) the load demand on the power converter exceeding a load demand threshold and a service age of the first set of capacitors exceeding a service age threshold, and
(b) the load demand on the power converter exceeding a load demand threshold and a one or more thresholds for a ripple current and a temperature of the first set of capacitors being exceed.

13. The process of claim 8, wherein:
the capacitor bank comprises a third set of capacitors selectably coupleable and decoupleable from the power bus by operation of a second switch, and
closing a second one of the one or more switches occurs in response to the plurality of conditions.

14. The process of claim 13, wherein a the closing the second one of the one or more switches occurs after the closing at least one of the one of the one or more switches.

15. An electronic control unit configured to control one or aspects of a powertrain system including a prime mover, the electronic control unit comprising:
one or more non-transitory controller readable media configured with instruction executable by a controller to:
operate the electronic control to output electrical power to one or more components of the powertrain system using a DC/DC power converter operatively coupled with a power supply and a capacitor bank operatively coupled with one of an input of the DC/DC power converter and an output of the power converter and including a set of dedicated capacitors coupled with a DC power bus and one or more auxiliary capacitors selectably coupled with the a DC power bus; and
close at least a first one of one or more switches to couple the one or more auxiliary capacitors with the DC power bus in response to a plurality of conditions including a load demand condition of the DC/DC power converter and one or more degradation conditions of the set of dedicated capacitors.

16. The electronic control unit of claim 15, wherein the load demand condition comprises a converter output power being greater than an output power threshold.

17. The electronic control unit of claim 15, wherein the one or more degradation conditions comprises a service duration of the electronic control unit being greater than a service duration threshold.

18. The electronic control unit of claim 15, wherein the one or more degradation conditions comprises a ripple current of the capacitor bank and a temperature of the first set of capacitors satisfying a ripple current and temperature criterion.

19. The electronic control unit of claim 15, wherein the instructions to close one or more switches are configured to occur in response to at least one of:
(a) the load demand on the power converter exceeding a load demand threshold and a service age of the first set of capacitors exceeding a service age threshold, and
(b) the load demand on the power converter exceeding a load demand threshold and a one or more thresholds for a ripple current and a temperature of the first set of capacitors being exceed.

20. The electronic control unit of claim 15, wherein the instructions to close one or more switches are configured to occur in response to both of:
(a) the load demand on the power converter exceeding a load demand threshold and a service age of the first set of capacitors exceeding a service age threshold, and
(b) the load demand on the power converter exceeding a load demand threshold and a one or more thresholds for a ripple current and a temperature of the first set of capacitors being exceed.
